(19) United States
(12) Patent Application Publication
(10) Pub. No.: US 2016/0124639 A1
(43) Pub. Date: May 5, 2016

(54) DYNAMIC STORAGE CHANNEL

(71) Applicant: SanDisk Technologies, Inc., Plano, TX (US)

(72) Inventors: Jea Hyun, Los Altos, CA (US); John Strasser, Kaysville, UT (US)

(21) Appl. No.: 14/599,267

(22) Filed: Jan. 16, 2015

Related U.S. Application Data
(60) Provisional application No. 62/075,799, filed on Nov. 5, 2014.

(51) Int. Cl. G06F 3/06

(52) U.S. Cl. CPC G06F 3/061; G06F 3/0685; G06F 3/0659

(57) ABSTRACT

Apparatuses, systems, methods, and computer program products are disclosed for a dynamic storage channel. A read module may be configured to direct a read command to one or more memory die in a row of an array of memory die to service a read request using one or more input/output (I/O) lines of the one or more memory die. Memory die in the row may have one or more common control lines. A channel module may be configured to direct a reserved command to one or more other memory die in the row of the array of memory die, using one or more I/O lines of the one or more other memory die.

### CROSS-REFERENCES TO RELATED APPLICATIONS

This application claims the benefit of U.S. Provisional Patent Application No. 62/075,799 entitled “Dynamic Storage Channel” and filed on Nov. 5, 2014, for Jea Hyun, et al., which is incorporated herein by reference.

### TECHNICAL FIELD

The present disclosure, in various embodiments, relates to data storage and more particularly relates to creating a dynamic virtual channel in a fixed physical channel.

### BACKGROUND

A memory device may include a plurality of memory elements in communication with a memory controller. Each memory element may be connected to the controller by one or more control lines and/or data lines, which allow the controller to set various states of individual memory elements and send/receive data, addresses, commands, etc., to/from individual memory elements. Connecting each memory element of a memory device to a controller may require the use of a large number of pins located on the controller.

Memory elements may be grouped together by sharing control lines, which minimizes the number of pins used on the controller. By sharing control lines, however, one or more memory elements of the connected group of memory elements may be unnecessarily enabled or accessed, for example, if one or more memory elements do not store data that is the subject of a read request. Unnecessarily enabling or accessing a memory element may waste power, increase wear, or cause amplification of disturbances in the memory element, such as read disturb effects.

### SUMMARY

Methods are presented for a dynamic storage channel. In one embodiment, a method includes sending a command to read data of a read request to a first set of one or more memory elements of a group of memory elements. In certain embodiments, enable lines for the group of memory elements are coupled together in parallel. In a further embodiment, a method includes sending a command that is not a read command to a second set of one or more memory elements of the group of memory elements. In one embodiment, the second of one or more memory elements does not store data of the read request. In some embodiments, a method includes transferring the data of the read request to service the read request.

Apparatuses are presented for a dynamic storage channel. In one embodiment, a read module is configured to direct a read command to one or more memory die in a row of an array of memory die to service a read request using one or more input/output (I/O) lines of the one or more memory die. In certain embodiments, memory die in the row have one or more common control lines. In a further embodiment, a channel module is configured to direct a reserved command to one or more other memory die in the row of the array of memory die, using one or more I/O lines of the one or more other memory die.

Systems are presented for a dynamic storage channel. A system, in one embodiment, includes a first integrated circuit of storage that receives a read command. In another embodiment, a system includes a second integrated circuit of storage that receives a pseudo-command. In a further embodiment, a system includes a third integrated circuit of storage that receives a read command. In some embodiments, a system includes one or more enable lines electrically connecting the first, second, and third integrated circuits of storage in parallel such that the first, second, and third integrated circuits of storage are enabled in parallel to receive the read commands and the pseudo-command.

### BRIEF DESCRIPTION OF THE DRAWINGS

A more particular description is included below with reference to specific embodiments illustrated in the appended drawings. Understanding that these drawings depict only certain embodiments of the disclosure and are not therefore to be considered to be limiting of its scope, the disclosure is described and explained with additional specificity and detail through the use of the accompanying drawings, in which:

FIG. 1 is a schematic block diagram of one embodiment of a system comprising a command management module;

FIG. 2 is a schematic block diagram illustrating one embodiment of a command management module;

FIG. 3A is a schematic block diagram illustrating one embodiment of a system for a dynamic channel;

FIG. 3B is a schematic block diagram illustrating a further embodiment of a system for a dynamic channel;

FIG. 4 is a schematic flow chart diagram illustrating one embodiment of a method for a dynamic channel; and

FIG. 5 is a schematic flow chart diagram illustrating a further embodiment of a method for a dynamic channel.

### DETAILED DESCRIPTION

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

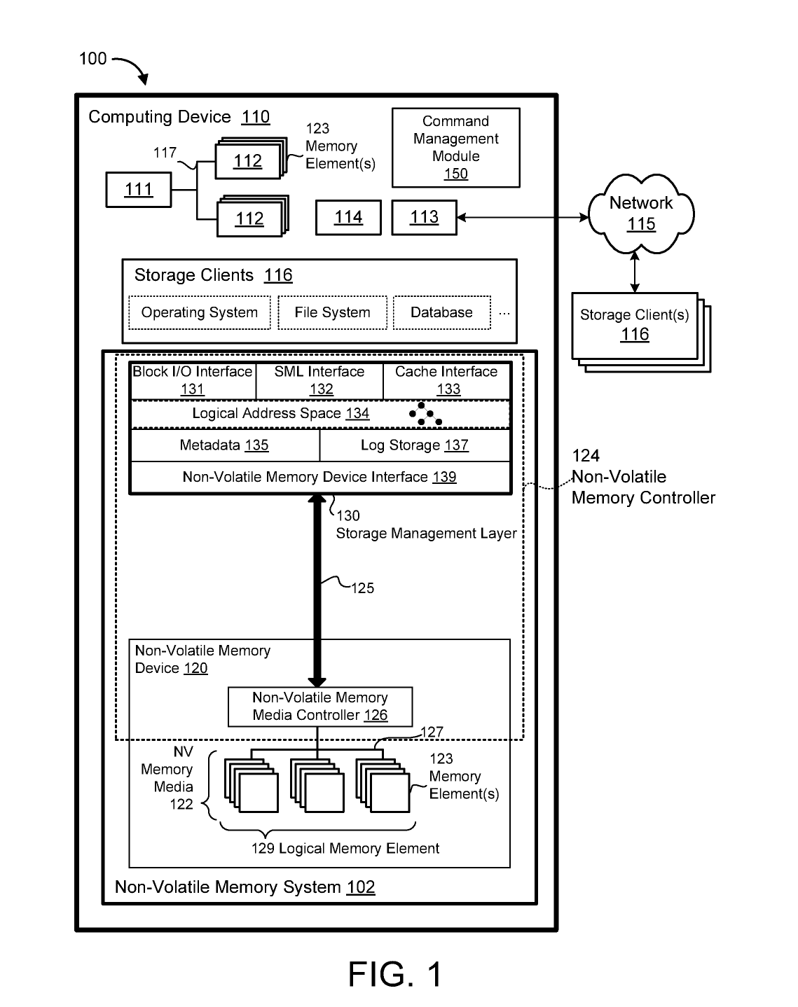

FIG. 1 is a block diagram of one embodiment of a system 100 comprising a command management module 150. The command management module 150 may be part of and/or in communication with one or more of a non-volatile memory controller 124, a non-volatile memory media controller 126, a device driver or storage management layer (SML) 130, or the like. The command management module 150 may operate on a non-volatile memory system 102 of a computing device 110, which may comprise a processor 111, volatile memory media 112, and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 and/or non-volatile memory controller 124 to a communication network 115, such as an Internet Protocol network, a Storage Area Network, or the like.

The volatile memory media 112 may include, but is not limited to: random access memory (RAM), static RAM (SRAM) (e.g., asynchronous SRAM, synchronous SRAM, bipolar junction transistor SRAM, MOSFET SRAM, zero bus turnaround SRAM, syncBurst SRAM, DDR SRAM, quad data rate SRAM, binary SRAM, ternary SRAM, or the like), dynamic RAM (DRAM) (e.g., asynchronous DRAM, video DRAM (VRAM), window DRAM (WRAM), fast page mode DRAM (FPM DRAM), extended data out DRAM (EDO DRAM), burst EDO DRAM (BEDO DRAM), multibank DRAM (MDRAM), synchronous graphics RAM (SGRAM), synchronous DRAM (SDRAM), single data rate SDRAM (SDR SDRAM), double data rate SDRAM (DDR SDRAM), direct rambus DRAM (DRDRAM), pseudostatic RAM (PSRAM), reduced latency DRAM (RLDRAM), or the like), thyristor RAM (T-RAM), zero-capacitor RAM (Z-RAM), or the like. While the volatile memory media 112 is referred to herein as “memory media,” in various embodiments, the volatile memory media 112 may more generally comprise a volatile recording media capable of recording data, which may be referred to as a volatile memory media, a volatile storage media, or the like.

The volatile memory media 112 may comprise one or more memory elements 123 comprising volatile memory elements 123. As used herein, a volatile memory element 123 comprises a physical unit of a volatile recording medium, a volatile memory medium, a volatile storage medium, or the like. A volatile memory element 123 may include, but is not limited to: a chip, a package, a die, a die plane, or another integrated circuit of memory or storage. A processor 111 may be configured to manage memory operations on the volatile memory media, and may comprise a memory manager, memory management unit (MMU), volatile memory controller, memory chip controller (MCC), integrated memory controller (IMC), firmware for managing memory operations, or the like. In some embodiments, the processor 111 is configured to store data in and/or read data from the volatile memory media 112 and to transfer data to/from the volatile memory media 112, and so on.

The processor 111 may be communicatively coupled to the volatile memory media 112 by way of a memory bus 117. The bus 117 may comprise an I/O bus for communicating data to/from the volatile memory elements 123. The bus 117 may further comprise a control bus (e.g., one or more control lines, enable lines, address lines, or the like) for enabling, communicating addressing and/or other command and control information for the volatile memory elements 123, or the like. In some embodiments, the bus 117 may communicatively couple the volatile memory elements 123 to the processor 111 in parallel. This parallel access may allow the volatile memory elements 123 to be managed as a group 320, forming a logical memory element, logical memory unit, or the like.

The computing device 110 may further comprise a non-transitory, computer readable storage media 114. The computer readable storage media 114 may comprise executable instructions configured to cause the computing device 110 (e.g., processor 111) to perform steps of one or more of the methods disclosed herein. Alternatively, or in addition, the command management module 150 may be embodied as one or more computer readable instructions stored on the non-transitory storage media 114.

The computing device 110, in the depicted embodiment, includes a command management module 150. The command management module 150, in one embodiment, is configured to send commands to memory elements 123 of a memory medium 112, 122 (e.g., a volatile memory medium 112 and/or a non-volatile memory medium 122), such as read commands, write or program commands, erase commands, volatile memory load or store commands, or the like. In certain embodiments, as described in greater detail below, enable lines or other control lines for certain memory elements 123 are coupled together in parallel and/or tied to the same pin of the non-volatile memory media controller 126 to form a group or channel of storage.

As used herein, a storage channel may comprise one or more elements, blocks, regions, or the like of memory media 112, 122 that may be accessed or used in parallel, at or near the same time, or the like. In certain embodiments, a storage channel may comprise one or more volatile memory elements 123 of volatile memory media 112 and/or one or more non-volatile memory elements 123 of non-volatile memory media 122. In one embodiment, a storage channel may comprise a dynamic storage channel. As used herein, a dynamic storage channel may comprise a storage channel in which the elements, blocks, regions, or the like of memory media 112, 122 that are accessed as part of the storage channel may be adjusted, changed, grouped, and/or selected differently for different commands or operations. In certain embodiments, a dynamic storage channel may be physically or electrically configurable using one or more electrical elements or logic hardware, such as switches, control gates, multiplexers, or the like. In some embodiments, a dynamic channel may be virtually or logically configurable using different commands, while the physical and/or electrical configuration remains the same. For example, a virtual storage channel, as used herein, may comprise a subset of memory elements, blocks, regions, or the like of a storage channel that are grouped by virtue of receiving the same command (e.g., a different command than one or more other memory elements, blocks, regions, or the like of the storage channel).

The command management module 150, in one embodiment, may send a read command to a first set 320 of one or more memory elements 123 in the same channel or group of memory elements 123, in response to a read request from a storage client 116 or the like. In a further embodiment, the command management module 150 may send a different command that is not a read command to a second set 320 of one or more memory elements 123 of the same group or channel of memory elements 123, in parallel with sending the read command, since control lines or enable lines for the group or channel of memory elements 123 are coupled together.

In certain embodiments, the second set 320 of one or more memory elements 123, to which the command management module 150 sends the different command, does not store data of the read request. In this manner, the command management module 150 does not send a read command to memory elements 123 that do not store data of the read request (e.g., a second set 320 of memory elements 123), which may conserve power and prevent read disturbances on the memory elements 123 that do not store data of the read request. In one embodiment, the command management module 150 may transfer the data of the read request in order to service the read request from the first set 320 of memory elements 123 which received read commands, without executing an unnecessary read command on the other, second set 320 of memory elements 123.

In one embodiment, the command management module 150 may comprise executable software code, such as a device driver, SML 130, or the like, stored on the computer readable storage media 114 for execution on the processor 111. In another embodiment the command management module 150 may comprise logic hardware of one or more non-volatile memory devices 120, such as a non-volatile memory media controller 126, a non-volatile memory controller 124, a device controller, a field-programmable gate array (FPGA) or other programmable logic, firmware for an FPGA or other programmable logic, microcode for execution on a microcontroller, an application-specific integrated circuit (ASIC), or the like. In a further embodiment, the command management module 150 may include a combination of both executable software code and logic hardware.

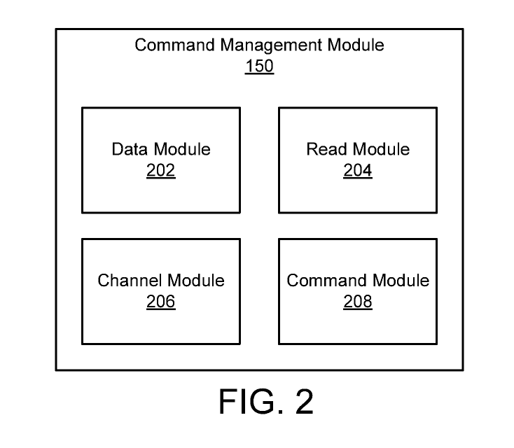

In one embodiment, the command management module 150 is configured to receive storage requests from the SML 130 via a bus 125 or the like. The command management module 150 may be further configured to transfer data to/from the SML 130 and/or storage clients 116 via the bus 125. Accordingly, the command management module 150, in some embodiments, may comprise and/or be in communication with one or more direct memory access (DMA) modules, remote DMA modules, bus controllers, bridges, buffers, and so on to facilitate the transfer of storage requests and associated data. In another embodiment, the command management module 150 may receive storage requests as an API call from a storage client 116, as an IO-CTL command, or the like. The command management module 150 is described in greater detail below with regard to FIG. 2.

According to various embodiments, a non-volatile memory controller 124 may comprise the command management module 150 or a portion thereof and may manage one or more non-volatile memory devices 120. Alternatively or in addition, as described above, a processor 111 and/or an associated memory manager or controller may comprise the command management module 150 or a portion thereof. The non-volatile memory device(s) 120 may comprise recording, memory, and/or storage devices, such as solid-state storage device(s), that are arranged and/or partitioned into a plurality of addressable media storage locations. As used herein, a media storage location refers to any physical unit of memory (e.g., any quantity of physical storage media on a non-volatile memory device 120). Memory units may include, but are not limited to: pages, memory divisions, erase blocks, sectors, blocks, collections or sets of physical storage locations (e.g., logical pages, logical erase blocks, described below), or the like.

The non-volatile memory controller 124 may comprise an SML 130, which may present a logical address space 134 to one or more storage clients 116. One example of an SML is the Virtual Storage Layer® of Sandisk, Inc. of Milpitas, Calif. Alternatively, each non-volatile memory device 120 may comprise a non-volatile memory media controller 126, which may present a logical address space 134 to the storage clients 116. As used herein, a logical address space 134 refers to a logical representation of memory resources. The logical address space 134 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

The SML 130 may maintain metadata 135, such as a forward index, to map logical addresses of the logical address space 134 to media storage locations on the non-volatile memory device(s) 120. The SML 130 may provide for arbitrary, any-to-any mappings from logical addresses to physical storage resources. As used herein, an “any-to any” mapping may map any logical address to any physical storage resource. Accordingly, there may be no pre-defined and/or pre-set mappings between logical addresses and particular, media storage locations and/or media addresses. As used herein, a media address refers to an address of a memory resource that uniquely identifies one memory resource from another to a controller that manages a plurality of memory resources. By way of example, a media address includes, but is not limited to: the address of a media storage location, a physical memory unit, a collection of physical memory units (e.g., a logical memory unit), a portion of a memory unit (e.g., a logical memory unit address and offset, range, and/or extent), or the like. Accordingly, the SML 130 may map logical addresses to physical data resources of any size and/or granularity, which may or may not correspond to the underlying data partitioning scheme of the non-volatile memory device(s) 120. For example, in some embodiments, the non-volatile memory controller 124 is configured to store data within logical memory units that are formed by logically combining a plurality of physical memory units, which may allow the non-volatile memory controller 124 to support many different virtual memory unit sizes and/or granularities.

As used herein, a logical memory element 129 or channel 129 refers to a set of two or more memory elements 123 that are or are capable of being managed in parallel (e.g., via an I/O and/or control bus). A logical memory element 129 or channel 129 may comprise a plurality of logical memory units, such as logical pages, logical memory divisions (e.g., logical erase blocks), and so on. As used herein, a logical memory unit refers to a logical construct combining two or more physical memory units, each physical memory unit on a respective memory element 123 in the respective logical memory element 129 or channel 129 (e.g., each memory element 123 being accessible in parallel). As used herein, a logical memory division refers to a set of two or more physical memory divisions, each physical memory division on a respective memory element 123 in the respective logical memory element 129 or channel 129.

The logical address space 134 presented by the SML 130 may have a logical capacity, which may correspond to the number of available logical addresses in the logical address space 134 and the size and/or granularity of the data referenced by the logical addresses. For example, the logical capacity of a logical address space 134 comprising 2̂32 unique logical addresses, each referencing 2048 bytes (2 KiB) of data may be 2̂43 bytes. As used herein, a kibibyte (KiB) refers to 1024 bytes. In some embodiments, the logical address space 134 may be thinly provisioned. As used herein, a “thinly provisioned” logical address space 134 refers to a logical address space 134 having a logical capacity that exceeds the physical capacity of the underlying non-volatile memory device(s) 120. For example, the SML 130 may present a 64-bit logical address space 134 to the storage clients 116 (e.g., a logical address space 134 referenced by 64-bit logical addresses), which may exceed the physical capacity of the underlying non-volatile memory devices 120. The large logical address space 134 may allow storage clients 116 to allocate and/or reference contiguous ranges of logical addresses, while reducing the chance of naming conflicts. The SML 130 may leverage the any-to-any mappings between logical addresses and physical storage resources to manage the logical address space 134 independently of the underlying physical storage devices 120. For example, the SML 130 may add and/or remove physical storage resources seamlessly, as needed, and without changing the logical addresses used by the storage clients 116.

The non-volatile memory controller 124 may be configured to store data in a contextual format. As used herein, a contextual format refers to a self-describing data format in which persistent contextual metadata is stored with the data on the physical storage media 122. The persistent contextual metadata provides context for the data with which it is stored. In certain embodiments, the persistent contextual metadata uniquely identifies the data with which the persistent contextual metadata is stored. For example, the persistent contextual metadata may uniquely identify a sector or block of data owned by a storage client 116 from other sectors or blocks of data owned by the storage client 116. In a further embodiment, the persistent contextual metadata identifies an operation that is performed on the data. In a further embodiment, the persistent contextual metadata identifies a sequence of operations performed on the data. In a further embodiment, the persistent contextual metadata identifies security controls, a data type, or other attributes of the data. In a certain embodiment, the persistent contextual metadata identifies at least one of a plurality of aspects, including data type, a unique data identifier, an operation, and a sequence of operations performed on the data.

The persistent contextual metadata may include, but is not limited to: a logical address of the data, an identifier of the data (e.g., a file name, object id, label, unique identifier, or the like), reference(s) to other data (e.g., an indicator that the data is associated with other data), a relative position or offset of the data with respect to other data (e.g., file offset, etc.), data size and/or range, and the like. The contextual data format may comprise a packet format comprising a data segment and one or more headers. Alternatively, a contextual data format may associate data with context information in other ways (e.g., in a dedicated index on the non-volatile memory media 122, a memory division index, or the like).

In some embodiments, the contextual data format may allow data context to be determined and/or reconstructed based upon the contents of the non-volatile memory media 122, and independently of other metadata, such as the arbitrary, any-to-any mappings discussed above. Since the media location of data is independent of the logical address of the data, it may be inefficient or impossible to determine the context of data based solely upon the media location or media address of the data. Storing data in a contextual format on the non-volatile memory media 122 may allow data context to be determined without reference to other metadata. For example, the contextual data format may allow the metadata to be reconstructed based only upon the contents of the non-volatile memory media 122 (e.g., reconstruct the any-to-any mappings between logical addresses and media locations).

In some embodiments, the non-volatile memory controller 124 may be configured to store data on one or more asymmetric, write-once media 122, such as solid-state storage media. As used herein, a “write once” storage medium refers to a storage medium that is reinitialized (e.g., erased) each time new data is written or programmed thereon. As used herein, an “asymmetric” storage medium refers to a storage medium 122 having different latencies for different storage operations. Many types of solid-state storage media are asymmetric; for example, a read operation may be much faster than a write/program operation, and a write/program operation may be much faster than an erase operation (e.g., reading the media may be hundreds of times faster than erasing, and tens of times faster than programming the media).

The memory media 122 may be partitioned into memory divisions that can be erased as a group (e.g., erase blocks) in order to, inter alia, account for the asymmetric properties of the media 122 or the like. As such, modifying a single data segment in-place may require erasing the entire erase block comprising the data, and rewriting the modified data to the erase block, along with the original, unchanged data. This may result in inefficient “write amplification,” which may excessively wear the media 122. Therefore, in some embodiments, the non-volatile memory controller 124 may be configured to write data out-of-place. As used herein, writing data “out-of-place” refers to writing data to different media storage location(s) rather than overwriting the data “in-place” (e.g., overwriting the original physical location of the data). Modifying data out-of-place may avoid write amplification, since existing, valid data on the erase block with the data to be modified need not be erased and recopied. Moreover, writing data out-of-place may remove erasure from the latency path of many storage operations (e.g., the erasure latency is no longer part of the critical path of a write operation).

The non-volatile memory controller 124 may comprise one or more processes that operate outside of the regular path for servicing of storage operations (e.g., the “path” for performing a storage operation and/or servicing a storage request). As used herein, the “path for servicing a storage request” or “path for servicing a storage operation” (also referred to as the “critical path”) refers to a series of processing operations needed to service the storage operation or request, such as a read, write, modify, or the like. The path for servicing a storage request may comprise receiving the request from a storage client 116, identifying the logical addresses of the request, performing one or more storage operations on non-volatile memory media 122, and returning a result, such as acknowledgement or data. Processes that occur outside of the path for servicing storage requests may include, but are not limited to: a groomer, de-duplication, and so on. These processes may be implemented autonomously and in the background, so that they do not interfere with or impact the performance of other storage operations and/or requests. Accordingly, these processes may operate independent of servicing storage requests.

In some embodiments, the non-volatile memory controller 124 comprises a groomer, which is configured to reclaim memory divisions (e.g., logical or physical erase blocks) for reuse, using a garbage collection or other storage capacity recovery process. The write out-of-place paradigm implemented by the non-volatile memory controller 124 may result in obsolete or invalid data remaining on the non-volatile memory media 122. For example, overwriting data X with data Y may result in storing Y on a new memory division (e.g., rather than overwriting X in place), and updating the any-to-any mappings of the metadata to identify Y as the valid, up-to-date version of the data. The obsolete version of the data X may be marked as invalid, but may not be immediately removed (e.g., erased), since, as discussed above, erasing X may involve erasing an entire memory division, which is a time-consuming operation and may result in write amplification. Similarly, data that is no longer is use (e.g., deleted or trimmed data) may not be immediately removed. The non-volatile memory media 122 may accumulate a significant amount of invalid data.

A groomer process may operate outside of the critical path for servicing storage operations. The groomer process may reclaim memory divisions so that they can be reused for other storage operations. As used herein, reclaiming a memory division refers to erasing the memory division so that new data may be stored/programmed thereon. Reclaiming a memory division may comprise relocating valid data on the memory division to a new location. The groomer may identify memory divisions for reclamation based upon one or more factors, which may include, but are not limited to: the amount of invalid data in the memory division, the amount of valid data in the memory division, wear on the memory division (e.g., number of erase cycles), time since the memory division was programmed or refreshed, and so on.

The non-volatile memory controller 124 may be further configured to store data in a log format. As described above, a log format refers to a data format that defines an ordered sequence of storage operations performed on a non-volatile memory media 122. In some embodiments, the log format comprises storing data in a pre-determined sequence of media addresses of the non-volatile memory media 122 (e.g., within sequential pages and/or erase blocks of the media 122). The log format may further comprise associating data (e.g., each packet or data segment) with respective sequence indicators. The sequence indicators may be applied to data individually (e.g., applied to each data packet) and/or to data groupings (e.g., packets stored sequentially on a memory division, such as an erase block). In some embodiments, sequence indicators may be applied to memory divisions when the memory divisions are reclaimed (e.g., erased), as described above, and/or when the memory divisions are first used to store data.

In some embodiments the log format may comprise storing data in an “append only” paradigm. The non-volatile memory controller 124, using the log storage module 137 described below or the like, may maintain a current append point at a media address of the non-volatile memory device 120. The append point may be a current memory division and/or offset within a memory division. Data may then be sequentially appended from the append point. The sequential ordering of the data, therefore, may be determined based upon the sequence indicator of the memory division of the data in combination with the sequence of the data within the memory division. Upon reaching the end of a memory division, the non-volatile memory controller 124 may identify the “next” available memory division (e.g., the next memory division that is initialized and ready to store data). The groomer may reclaim memory divisions comprising invalid, stale, and/or deleted data, to ensure that data may continue to be appended to the media log.

The log format described herein may allow valid data to be distinguished from invalid data based upon the contents of the non-volatile memory media 122, and independently of other metadata. As discussed above, invalid data may not be removed from the non-volatile memory media 122 until the memory division comprising the data is reclaimed. Therefore, multiple “versions” of data having the same context may exist on the non-volatile memory media 122 (e.g., multiple versions of data having the same logical addresses). The sequence indicators associated with the data may be used to distinguish invalid versions of data from the current, up-to-date version of the data; the data that is the most recent in the log is the current version, and previous versions may be identified as invalid.

The storage management layer 130 may be configured to provide storage services to one or more storage clients 116. The storage clients 116 may include local storage clients 116 operating on the computing device 110 and/or remote, storage clients 116 accessible via the network 115 and/or network interface 113. The storage clients 116 may include, but are not limited to: operating systems, file systems, database applications, server applications, kernel-level processes, user-level processes, applications, and the like.

The storage management layer 130 comprises and/or is communicatively coupled to one or more non-volatile memory devices 120. The one or more non-volatile memory devices 120 may include one or more different types of non-volatile memory devices including, but not limited to: solid-state storage devices, hard drives, SAN storage resources, or the like. The one or more non-volatile memory devices 120 may comprise one or more respective non-volatile memory media controllers 126 and non-volatile memory media 122. As illustrated in FIG. 1, The SML 130 may provide access to the one or more non-volatile memory devices 120 via a traditional block I/O interface 131. Additionally, the SML 130 may provide access to enhanced functionality (e.g., a large, virtual address space 134) through the SML interface 132. The metadata 135 may be used to manage and/or track storage operations performed through any of the Block I/O interface 131, SML interface 132, cache interface 133, or other, related interfaces.

The cache interface 133 may expose cache-specific features accessible via the storage management layer 130. Also, in some embodiments, the SML interface 132 presented to the storage clients 116 provides access to data transformations implemented by the one or more non-volatile memory devices 120 and/or the one or more non-volatile memory media controllers 126.

The SML 130 may provide storage services through one or more interfaces, which may include, but are not limited to: a block I/O interface, an extended storage management layer interface, a cache interface, and the like. The SML 130 may present a logical address space 134 to the storage clients 116 through one or more interfaces. As discussed above, the logical address space 134 may comprise a plurality of logical addresses, each corresponding to respective media locations the on one or more non-volatile memory devices 120. The SML 130 may maintain metadata 135 comprising any-to-any mappings between logical addresses and media locations, as described above.

The SML 130 may further comprise a log storage module 137 that is configured to store data in a contextual, log format. The contextual, log data format may comprise associating data with persistent contextual metadata, such as the logical address of the data, or the like. The contextual, log format may further comprise associating data with respective sequence identifiers on the non-volatile memory media 122, which define an ordered sequence of storage operations performed on the one or more non-volatile memory devices 120, as described above.

The SML 130 may further comprise a non-volatile memory device interface 139 configured to transfer data, commands, and/or queries to the one or more non-volatile memory devices 120 over a bus 125, which may include, but is not limited to: a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 115, Infiniband, SCSI RDMA, or the like. The non-volatile memory device interface 139 may communicate with the one or more non-volatile memory devices 120 using input-output control (IO-CTL) command(s), IO-CTL command extension(s), remote direct memory access, or the like.

The communication interface 113 may comprise one or more network interfaces configured to communicatively couple the computing device 110 and/or the non-volatile memory controller 124 to a network 115 and/or to one or more remote, network-accessible storage clients 116. The storage clients 116 may include local storage clients 116 operating on the computing device 110 and/or remote, storage clients 116 accessible via the network 115 and/or the network interface 113. The non-volatile memory controller 124 comprises one or more non-volatile memory devices 120. Although FIG. 1 depicts a single non-volatile memory device 120, the disclosure is not limited in this regard and could be adapted to incorporate any number of non-volatile memory devices 120.

The non-volatile memory device 120 may comprise non-volatile memory media 122, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like. While the non-volatile memory media 122 is referred to herein as “memory media,” in various embodiments, the non-volatile memory media 122 may more generally comprise a non-volatile recording media capable of recording data, which may be referred to as a non-volatile memory media, a non-volatile storage media, or the like. Further, the non-volatile memory device 120, in various embodiments, may comprise a non-volatile recording device, a non-volatile memory device, a non-volatile storage device, or the like.

The non-volatile memory media 122 may comprise one or more non-volatile memory elements 123. As used herein, a non-volatile memory element 123 comprises a physical unit of a non-volatile recording medium, a non-volatile memory medium, a non-volatile storage medium, or the like. A non-volatile memory element 123 may include, but is not limited to: a chip, a package, a die plane, a die, or another integrated circuit of memory or storage. A non-volatile memory media controller 126 may be configured to manage storage operations on the non-volatile memory media 122, and may comprise one or more processors, programmable processors (e.g., field-programmable gate arrays), or the like. In some embodiments, the non-volatile memory media controller 126 is configured to store data on and/or read data from the non-volatile memory media 122 in the contextual, log format described above, and to transfer data to/from the non-volatile memory device 120, and so on.

The non-volatile memory media controller 126 may be communicatively coupled to the non-volatile memory media 122 by way of a bus 127. The bus 127 may comprise an I/O bus for communicating data to/from the non-volatile memory elements 123. The bus 127 may further comprise a control bus (e.g., one or more control lines, enable lines, or the like) for enabling, communicating addressing and other command and control information to the non-volatile memory elements 123, or the like. In some embodiments, the bus 127 may communicatively couple the non-volatile memory elements 123 to the non-volatile memory media controller 126 in parallel. This parallel access may allow the non-volatile memory elements 123 to be managed as a group, forming a logical memory element 129. As discussed above, the logical memory element may be partitioned into respective logical memory units (e.g., logical pages) and/or logical memory divisions (e.g., logical erase blocks). The logical memory units may be formed by logically combining physical memory units of each of the non-volatile memory elements 123. For example, if the non-volatile memory media 122 comprises twenty-five (25) non-volatile memory elements 123, each logical memory unit may comprise twenty-five (25) pages (e.g., a page of each element of non-volatile memory media 122).

The non-volatile memory controller 124 may comprise an SML 130 and the non-volatile memory media controller 126. The SML 130 may provide storage services to the storage clients 116 via one or more interfaces 131, 132, and/or 133. In some embodiments, the SML 130 provides a block-device I/O interface 131 through which storage clients 116 perform block-level I/O operations. Alternatively, or in addition, the SML 130 may provide a storage management layer (SML) interface 132, which may provide other storage services to the storage clients 116. In some embodiments, the SML interface 132 may comprise extensions to the block device interface 131 (e.g., storage clients 116 may access the SML interface 132 through extensions to the block device interface 131). Alternatively, or in addition, the SML interface 132 may be provided as a separate API, service, and/or library. The SML 130 may be further configured to provide a cache interface 133 for caching data using the non-volatile memory system 102.

As described above, the SML 130 may present a logical address space 134 to the storage clients 116 (e.g., through the interfaces 131, 132, and/or 133). The SML 130 may maintain metadata 135 comprising any-to-any mappings between logical addresses in the logical address space 134 and media locations on the non-volatile memory device 120. The metadata 135 may comprise a logical-to-physical mapping structure with entries that map logical addresses in the logical address space 134 and media locations on the non-volatile memory device 120. The logical-to-physical mapping structure of the metadata 135, in one embodiment, is sparsely populated, with entries for logical addresses for which the non-volatile memory device 120 stores data and with no entries for logical addresses for which the non-volatile memory device 120 does not currently store data. The metadata 135, in certain embodiments, tracks data at a block level, with the SML 130 managing data as blocks.

The non-volatile memory system 102 may further comprise a log storage module 137, which, as described above, may be configured to store data on the non-volatile memory device 120 in a contextual, log format. The contextual, log data format may comprise associating data with a logical address on the non-volatile memory media 122. The contextual, log format may further comprise associating data with respective sequence identifiers on the non-volatile memory media 122, which define an ordered sequence of storage operations performed on the non-volatile memory media 122, as described above. The non-volatile memory controller 124 may further comprise a non-volatile memory device interface 139 that is configured to transfer data, commands, and/or queries to the non-volatile memory media controller 126 over a bus 125, as described above.

FIG. 2 depicts one embodiment of a command management module 150. The command management module 150 may be substantially similar to the command management module 150 described above with regard to FIG. 1. In general, as described above, the command management module 150 is configured to send a command to read data of a read request to a first set 320 of memory elements 123, send a command that is not a read request to a second set 320 of memory elements 123, and transfer data of the read request to service the read request. In the depicted embodiment, the command management module 150 includes a data module 202, a read module 204, a channel module 206, and a command module 208, which are described in more detail below.

In one embodiment, the data module 202 is configured to select one or more memory elements 123 of a plurality of memory elements 123, such as volatile memory media 112 and/or the non-volatile memory media 122, for servicing a read request, a memory request, or the like. As described above, a memory element 123 may comprise a storage element, a die, a die plane, a chip, a package, an integrated circuit of storage, or the like. In one embodiment, a storage element may comprise a non-volatile storage element (e.g., a solid state storage element such as a NAND flash storage element), or the like. In certain embodiments, as described above, the non-volatile storage device 120 comprises a flash memory device, such as a NAND flash memory device, a NOR flash memory device, or the like.

In certain embodiments, a plurality of memory elements 123 (e.g., volatile and/or non-volatile memory elements 123) are accessible using physical or logical addresses, as described above. In some embodiments, the data module 202, determines addresses for one or more memory elements 123 that correspond to the read request, e.g., one or more memory elements 123 that contain data for the read request. In certain embodiments, the data module 202 refers to a map, an index, or the like, to determine a logical or a physical address for a memory element 123. For example, the data module 202 may determine the physical addresses for data in a group or channel of memory elements 123 by looking up the logical addresses for the data in a map and determining the corresponding physical addresses in the memory elements 123.

In one embodiment, the data module 202 selects one or more memory elements 123 of a two-dimensional array of memory elements 123. In certain embodiments, the one or more memory elements 123 are arranged in a row or a column of the two-dimensional array. In some embodiments, the selected memory elements 123 are physically connected together. For example, the one or more memory elements 123 may be electrically connected together via one or more control lines, enable lines, or the like (e.g., a control bus 127), and may also be electrically connected to a controller (e.g., a non-volatile memory media controller 126, a non-volatile memory controller 124, a CPU 111, a memory manager, a memory controller, or the like). In one embodiment, a plurality of memory elements 123 share one or more control lines, enable lines, or the like, which are connected to a controller 126.

As used herein, a control line comprises an electrical line or connection between the processor 111, the controller 126, or the like, and one or more memory elements 123, which the processor 111 or controller 126 may use to manage operation of the memory element 123. For example, the controller 126 may use a control line to activate or enable a memory element 123, to indicate to a memory element 123 what data or type of data the memory element 123 is to receive from the controller 126 on separate I/O lines (e.g., a command, an address, data), or the like. In certain embodiments, a control line may comprise an address latch control line (e.g., to indicate that the memory element 123 is receiving an address on the I/O lines), a command latch control line (e.g., to indicate that the memory element 123 is receiving a command on the I/O lines), a data latch control line (e.g., to indicate that the memory element 123 is receiving data on the I/O lines), or the like that sets a corresponding state on a memory element 123. For example, the controller 126 may use one or more control lines (e.g., an address latch, a command latch, a data latch) to indicate that the memory element 123 may expect to receive addresses, commands, or data on the I/O lines when the corresponding control line is set. A control line and/or an I/O line may electrically couple or connect an input and/or output pin of the processor 111, the controller 126, or the like, and an input and/or output pin of a memory element 123, conducting electrical signals between the two.

An enable line, as used herein, comprises a control line, bus, or wire that the processor 111, the controller 126, or the like, may use to activate or enable a memory element 123 for a predefined action, such as reading data, writing data, or the like. In certain embodiments, an enable line may comprise a chip enable line, a write enable line, a read enable line, a command latch enable line, an address latch enable line, or the like. A chip enable line may place a memory element 123 in standby mode when not asserted, during which the memory element 123 does not respond to any control signals, place the memory element 123 in an active or ready state when asserted, or the like. The processor 111, the controller 126, or the like may use a write enable line to clock in commands, addresses, and/or data for a memory element 123, in response to a write request or the like from a storage client 116. The processor 111, the controller 126, or the like may use a read enable line to enable the output data buffers of a memory element 123 in response to a read request or the like from a storage client 116. For example, the controller 126 may set a memory element 123 to a read enable state by asserting the read enable line, so that the memory element 123 is enabled to service a read request. The processor 111, the controller 126, or the like may use a command latch enable line to latch into or otherwise provide a command to a memory element 123 (e.g., latching a command into a command register of a memory element 123 while the command latch enable line is high or the like). The controller 126 may use an address latch enable line to latch into or otherwise provide an address for a command to a memory element 123 (e.g., latching an address into an address register of a memory element 123 while the address latch enable line is high or the like).

In some embodiments, the controller 126 comprises a field-programmable gate array (FPGA), an application-specific integrated circuit (ASIC), or the like. An FPGA, ASIC, or other controller 126, a processor 111, or the like, may include one or more pins that are coupled and/or connected to one or more control lines, one or more pins that are coupled and/or connected to one or more I/O lines, which the controller 126 and/or the processor 111 may use to send/receive addresses, commands, data, or the like. The control lines and/or I/O lines may electrically connect the pins of the processor 111 and/or the controller 126 to corresponding pins of the memory elements 123, e.g., volatile and/or non-volatile memory elements 123. The data module 202 may determine which memory elements 123 to select as a function of determining which memory elements 123 share a control line (e.g., an enable line). For example, a row of NAND flash memory die may be physically connected as a function of sharing a chip enable control line such that all the die within the row are activated or enabled at the same time. In this manner, several memory elements 123 (e.g. a row of memory elements 123 in an array) may share a control line instead of using a separate control line for each memory element 123, which conserves the number of usable pins on the controller 126.

In such an embodiment, however, not every memory element 123 that shares a control line may contain data of a read request or other storage request. Some memory elements 123, therefore, may be unnecessarily enabled, activated, accessed, or the like, due to the control lines (e.g., control lines that memory elements have in common), which may have unintended side effects, such as causing a read disturb, consuming extra power, or the like. In order to prevent unnecessarily reading data from a memory element 123 that does not contain data of a read request, the channel module 206 described below may send a NOOP command, a dummy command, a pseudo-command, a reserved command, or the like to one or more memory elements 123 selected by the data module 202 that do not contain data of a read request.

The data module 202, in certain embodiments, is configured to send and/or transfer data of a read request to service the read request. In some embodiments, the data module 202 may receive and/or transfer data of a read request using one or more I/O lines (e.g., receive data from a read buffer or other output data buffer of a non-volatile memory element 123 over one or more I/O lines). As used herein, an I/O line comprises an electrical line or connection between the processor 111, the controller 126, or the like, and a memory element 123, which the processor 111 and/or the controller 126 may use to provide and/or receive data associated with a storage command (e.g., a read command, a write command, and/or an erase command). For example, the controller 126 may send a read command, an address, or the like for a read request over the I/O lines and may receive data of the read request over the I/O lines in response.

The data module 202 may transfer the data of the read request to a storage client 116, to volatile memory media 112 of the host computing device 110, or the like over the bus 125, for satisfying a read request received over the block I/O interface 131, the SML interface 132, the cache interface 133, or the like. In certain embodiments, each memory element 123, e.g., non-volatile memory elements 123, of the memory device 120 may have independent, separate I/O lines connecting the memory elements 123 to the controller 126. Similarly, in some embodiments, each memory element 123 (e.g. volatile memory elements 123), may have independent, separate I/O lines connecting the memory elements 123 to the processor 111, a memory manager, a memory controller, or the like. Therefore, unlike the control or enable lines, which may be shared between a plurality of memory elements 123, each memory element 123 may have its own I/O lines.

The read module 204, in one embodiment, is configured to send, direct, or otherwise transmit a read command or other command to read data of a read request to a first set 320 of one or more memory elements 123 of a group of memory elements 123 of the non-volatile memory device 120. As used herein, a read command or other command to read data comprises a command or other instruction to retrieve stored data from one or more addresses of a memory element 123. In certain embodiments, the read module 204 sends read commands from the processor 111 and/or the controller 126 to one or more memory elements 123 using one or more dedicated I/O lines that connect the processor 111 and/or the controller 126 to a memory element 123, in coordination with and/or according to a timing of a chip enable signal, a read enable signal, or the like sent to the memory element 123 using one or more control lines. Thus, unlike the control lines that are shared between a group of memory elements 123 within a row of a memory element array, for example, the I/O lines may not be shared such that each memory element 123 may communicate I/O data with the processor 111 and/or the controller 126 using its own independent one or more I/O lines.

In certain embodiments, the first set 320 of memory elements 123 comprises one or more memory elements 123 of a group of memory elements 123 that comprises (e.g., stores) data for a read request. For example, the data module 202 may determine that memory elements 123 two, five, and six (e.g., the first set 320 of memory elements 123), of a row of eight memory elements 123, contain data of a read request. Because each memory element 123 of the row of eight memory elements 123 shares one or more control lines (e.g., enable lines), all eight memory elements 123 of the row may be enabled, activated, accessed, or the like, in parallel. The read module 204 may then send a read command to the first set 320 of memory elements 123 (e.g., memory elements two, five, and six) in order to service the read request.

Memory elements zero, one, three, four, and seven may comprise a second set 320 of memory elements 123 that do not contain data of the read request; however, these memory elements 123 may nevertheless be enabled, activated, accessed, or the like because they share a common control line (e.g., enable line) with the first set 320 of memory elements 123. In certain embodiments, the second set 320 of one or more memory elements 123 may comprise one or more memory elements 123 that have been retired from storing data (e.g., based on an error rate, failure, age, or the like).

In order to prevent the second set 320 of memory elements 123 from being unnecessarily accessed or read, the channel module 206, in one embodiment, is configured to send, direct, or otherwise transfer a command that is not a read command, a command having no associated function, a dummy command, a pseudo-command, an unassigned command, a reserved command, an invalid address, an invalid voltage threshold (e.g., an invalid read voltage threshold), or the like to the second set 320 of one or more memory elements 123 of the group of memory elements 123 that do not store data of the read request. For simplicity, as used herein, the various commands that may be sent to the second set 320 of memory elements 123 are collectively known as a non-read command.

As used herein, a non-read command may comprise a command that is not associated with servicing a read request from one or more memory elements 123 (e.g., a command that is not a read command) and/or a command that does not cause a valid read operation to be performed on one or more memory elements 123. For example, a non-read command may comprise a write or program command, an erase command, an unassigned command, a reserved command, a NOOP command, a pseudo-command, a dummy command, or the like.

Further, a command having no associated function, a dummy command, and/or a pseudo-command, as used herein, may comprise a command that has not been assigned a function or otherwise does not have an associated operation. For example, such a command may be an invalid command, a reserved command, an unassigned command, a NOOP command, or the like such that when the command is received at a memory element 123, no operations, functions, or the like are performed on the memory element 123.

An unassigned command or reserved command, as used herein, may comprise a command that has not been associated with a corresponding function or operation. For example, in one embodiment, an unassigned command may comprise an operation code (opcode) reserved by a manufacturer that does not currently have an associated function, but may be assigned or associated with a function at some time in the future. The reserved opcode may be specific to a type of memory element 123, such as a RAM chip, die, or the like, a NAND chip, die, or the like, a manufacturer or vendor of the volatile memory media 112, the non-volatile memory media 122, or the like. For example, Table 1 below shows an example of various opcodes for an example NAND chip:

TABLE 1

| Type | opcode |
|---|---|
| Standard | 00h, 05h-06h, 10h-11h, 15h, 30h-32h, 35h, 3Fh, 60h, |
| Command Set | 70h, 78h, 80h-81h, 85h, 90h, D0h-D1h, D4h-D5h, |
| | D9h, E0h-E2h, ECh-EFh, F1h-F2h, F9h, FAh, FCh, |
| | FFh |
| Vendor | 01h-04h, 07h-0Ah, 0Ch-0Fh, 13h, 16h-17h, 19h- |
| Specific | 1Ah, 1Dh-2Fh, 33h-34h, 36h-3Eh, 40h-5Fh, 61h, 65h- |
| | 6Fh, 71h-75h, 77h, 79h-7Fh, 84h, 87h-8Dh, 8Fh, 91h- |
| | CFh, D2h-D3h, D6h-D8h, DAh-DFh, E3h-EBh, |
| | F0h, F3h-F8h, FBh, FD-FEh |
| Reserved | 0Bh, 12h, 14h, 18h, 1Bh-1Ch, 62h-64h, 76h, 82h-83h, |
| | 86h, 8Eh |

For example, the reserved opcode 76h may be used as a no operation (NOOP) command until or unless the opcode is assigned an operation. As used herein, a NOOP command may be a command that does nothing, e.g., has little or no effect, performs no operation, or the like. In such an embodiment, a memory element 123 may recognize the NOOP opcode as a command, but because the command has no associated function, the memory element 123 does not perform an operation. In another embodiment, a memory element 123 may not recognize a NOOP opcode as a command, may recognize a NOOP opcode as an invalid command, may recognize a NOOP opcode as a reserved command, or the like. A reserved NOOP command, as used herein, may comprise a command that has been specifically defined as a NOOP command such that when the command is received at a memory element 123, no operations are performed on the memory element 123. In this manner, by sending a command that is not a read command, a command having no associated function, a dummy command, a pseudo-command, an unassigned command, a reserved command, a NOOP command, or the like to the second set 320 of memory elements 123 (e.g., one or more memory elements 123 that do not store data of a read request) power may be conserved and the negative side effects caused by read disturbs may be minimized because the second set 320 of memory elements 123 are not enabled, accessed, read, or the like.

In certain embodiments, the non-read command that is sent to the second set 320 of memory elements 123 may comprise a read command with an invalid address. As used herein, an invalid address may comprise an address that is not accessible on a memory element 123, does not store data on a memory element 123, or the like. For example, the non-read command may comprise a read command with a null address, an out-of-bounds address, or an address that is otherwise an invalid address for any of the memory elements 123 of the second set 320 of memory elements 123.

In a further embodiment, a non-read command may comprise a read command with an invalid read voltage threshold. As used herein, an invalid read voltage threshold may comprise a read voltage threshold that is out of bounds or not within an allowed voltage range to service a read request, or the like.

By using an invalid address and/or an invalid read voltage threshold as a non-read command and/or an invalid read command, the second set 320 of memory elements 123 may fail to perform a valid read operation, may perform no operation, may use less power than a valid read command, may cause little or no read disturb effects, or the like. Sending an invalid address and/or an invalid read voltage threshold to memory elements 123 that do not store data of a read request, in certain embodiments, allows memory elements 123 to share one or more control lines of the processor 111 and/or the controller 126 in order to reduce the number of control line pins of the processor 111 and/or the controller 126 that are used.

In one embodiment, the read module 204 and the channel module 206 send the command to read the data and the non-read command in parallel, because a row or other set of memory elements 123 are coupled together and enabled and/or activated in parallel. In some embodiments, the read module 204 aggregates or combines a plurality of read requests for different memory elements 123 such that the plurality of read requests are sent in parallel, together with one or more non-read commands. In certain embodiments, the non-read command uses less power per memory element 123 than the read command uses per memory element 123, because, as described above, little or no power is used to access the second set 320 of memory elements 123 that receive a non-read command.

The command module 208, in one embodiment, is configured to select a different command for the non-read command for a subsequent operation in response to the opcode being associated with a function, an operation, or the like. For example, an unused or reserved opcode for a NAND chip manufacturer may be updated by the manufacturer such that the opcode is associated with a function for the NAND chip. In such an embodiment, upon determining that the opcode has been assigned a function or is no longer a reserved opcode, the command module 208 may select a different opcode for the non-read command.

For example, referring to Table 1 above, if a NAND chip manufacturer assigns a function, an operation, a command, or the like to opcode 76h, which was previously used by the channel module 206 as a NOOP command sent to the second set 320 of one or more memory elements 123, the command module 208 may select a different opcode that does not have an associated function for the NOOP command, such as opcode 86h, for example. The command module 208 may select one of various reserved opcodes, unassigned opcodes, or opcodes that are not associated with a read command, as the opcode for a non-read command, which the channel module 206 sends to the second set 320 of one or more memory elements 123.

In one embodiment, the command module 208 stores the selected or updated opcode for the different non-read command in a register of the memory device 120, in the non-volatile memory media 122 (e.g., at a predefined address or known location), or the like, allowing the command module 208 to dynamically access and/or update the opcode, so that the opcode is configurable. In certain embodiments, the command module 208 reads the non-read command, or an opcode representing the non-read command, from the register or other known location. For example, referring again to Table 1 above, the command module 208 may read opcode 76h from the register, which may have previously been used as the opcode for a NOOP command by the channel module 206. However, if the command module 208 determines that 76h has been assigned a function or is otherwise unavailable to be used as a opcode for a NOOP command, the command module 208 may select a different opcode from a list of available opcodes, such as the list of reserved opcodes in Table 1 above, and store the selected opcode in the register to be used for subsequent operations.

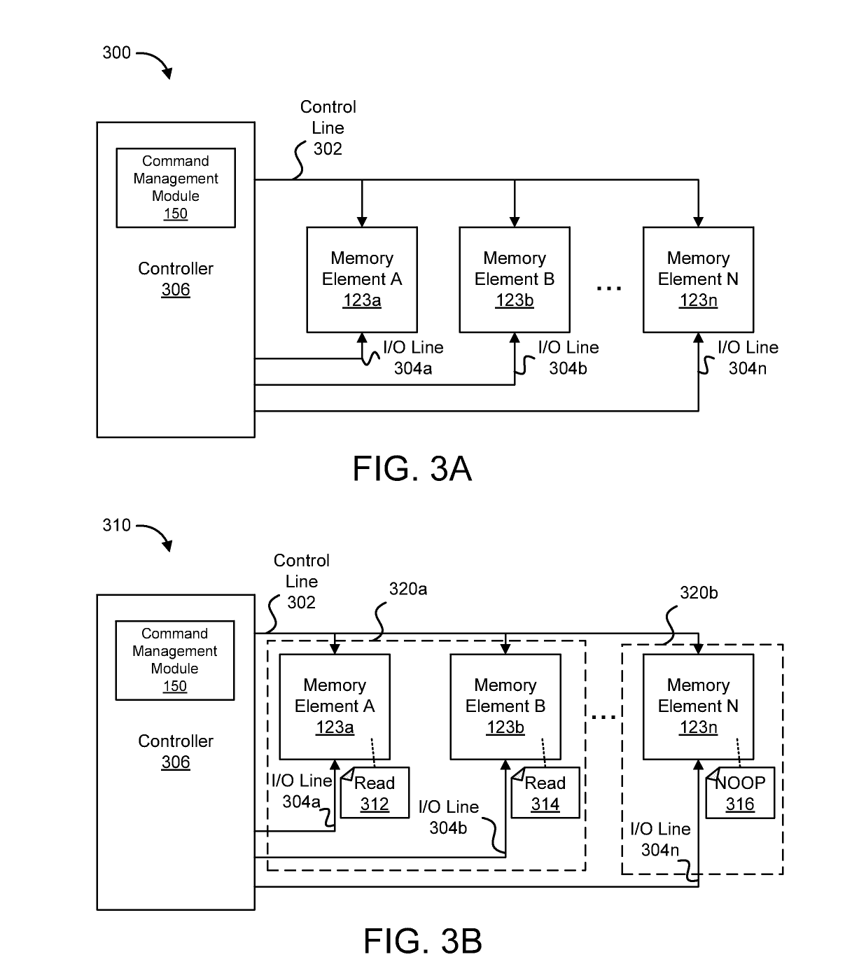

FIG. 3A depicts one embodiment of a system 300 for a dynamic channel. In one embodiment, the system 300 comprises a controller 306, which may include the processor 111, the controller 126, or the like, a command management module 150, a plurality of memory elements 123a-n (e.g., volatile and/or non-volatile memory elements 123), control lines 302, and a plurality of I/O lines 304a-n. Even though only one control line 302 is depicted in the system 300, in certain embodiments, a plurality of control lines 302 may couple the memory elements 123a-n to the controller 306. In certain embodiments, the memory elements 123a-n comprise a row of an array of non-volatile memory elements 123a-n for a storage device 120, such as a NAND flash memory device. In some embodiments, the memory elements 123 comprise a row of an array of volatile memory elements 123a-n for a volatile memory device, such as a RAM device.

As shown in FIG. 3A, the memory elements 123a-n all share control lines 302 (e.g., enable lines). The control lines 302 may each be connected to a pin of the controller 306 that sets a particular state of a non-volatile memory element 123a-n. For example, the controller 306 may include control lines to set a write enable state, a read enable state, a command latch state, an address latch state, a chip enable state, or the like, of the memory elements 123a-n. Because each of the memory elements 123a-n are connected in parallel to the same control lines 302, when a particular enable state is set via a control line 302, each of the memory elements 123a-n are set to that state. In this manner, the number of pins on the controller 306 that are used for control lines 302 may be reduced because each memory element 123a-n shares the same control lines. Thus, instead of having a separate chip enable control line 302 for each memory element 123a-n, each memory element 123a-n shares the same chip enable control line 302.

In one embodiment, each memory element 123a-n has an independent I/O connection to the controller 306 via one or more I/O lines 304a-n. The I/O lines 304a-n may be used to send address information, command information, and/or data between the controller 306 and the memory elements 123a-n. In certain embodiments, the state of the control lines 302 determines what information the memory elements 123a-n should expect to receive on the I/O lines 304a-n. For example, if the control line 302 for a command latch state is set, the memory elements 123a-n may expect to receive a command on the I/O lines 304a-n.

FIG. 3B depicts a further embodiment of a system 310 for a dynamic channel. The system 310 of FIG. 3B may be substantially similar to the system 300 of FIG. 3A. In addition, in the system 310 of FIG. 3B, the controller 306 and/or the command management module 150 have sent read commands 312, 314, and NOOP commands 316 to the memory elements 123a-n. In particular, the command module 150 and/or the controller 306 have sent read commands 312, 314 to a first set 320a or group 320a of memory elements 123 and NOOP commands 316 to a second set 320b or group 320b of memory elements 123. In one embodiment, as described above, a virtual channel may be created by physically connecting a plurality of memory elements 123a-n to a controller 306 via control lines 302; however, in such an embodiment, in order to service a read request, for example, the controller 306 and/or the command management module 150 may enable, activate, or otherwise make accessible each memory element 123a-n of the row of memory elements 123a-n because each memory element 123a-n shares control lines 302 (e.g., enable lines 302).

In certain embodiments, at least one memory element 123a-n of the row of connected memory elements 123a-n does not store data of a read request (e.g., memory element N 123n). In some embodiments, in order to prevent servicing a read request by accessing, or attempting to read data of the read request, from a memory element 123a-n that does not store data of the read request, the command management module 150 may send a non-read command 316, such as a command that is not a read command, an unassigned command, a reserved command, a pseudo-command, a NOOP command, a dummy command, a command without an associated function, an invalid address, or the like to one or more memory elements 123a-n that do not store data of the read request.

In particular, a data module 202 may determine a first set 320a of memory elements 123a-n that store data of the read request and a second set 320b of memory elements 123a-n that do not store data of the read request. In the depicted embodiment, for example, memory elements A 123a and B 123b store data of the read request, and comprise the first set 320a of memory elements 123a-n, and memory element N 123n does not store data of the read request, and comprises the second set 320b of memory elements 123a-n.

The read module 204, in certain embodiments, sends read commands 312, 314 for one or more read requests to the first set 320a of memory elements 123a-n, memory elements A 123a and B 123b. A channel module 206, in some embodiments, sends a non-read command 316, e.g., a reserved NOOP command 316, to the second set 320b of memory elements 123a-n, memory element N 123n, such that the second set 320b of memory elements 123a-n is not read or accessed in response to the read request. In certain embodiments, the read module 204 and the channel module 206 send the respective read commands 312, 314 and reserved NOOP commands 316 in parallel, using the I/O lines 304a-n or the like. In this manner, by sending a reserved NOOP command 316 to the second set 320b of non-volatile memory elements 123a-n that do not store data of the read request, a virtual channel may be created while conserving power and avoiding any negative side-effects of unnecessarily reading/accessing a non-volatile memory element 123a-n such as, for example, read/amplification disturbances.

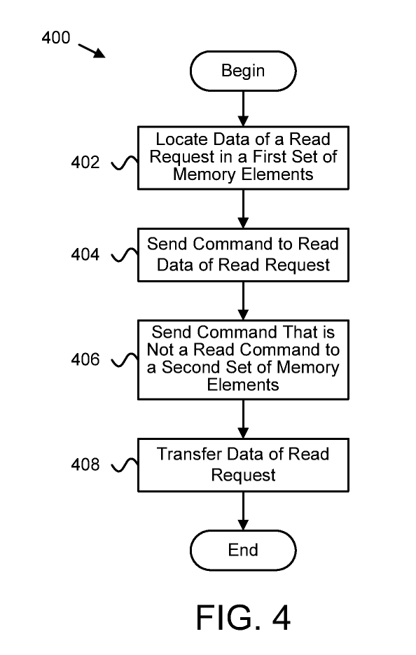

FIG. 4 depicts one embodiment of a method 400 for a dynamic channel. In one embodiment, the method 400 begins and the data module 202 locates 402 data of a read request in a first set 320 of one or more memory elements 123 of a group of memory elements 123. In certain embodiments, the group of memory elements 123 comprises a row of an array of non-volatile memory elements 123 of a non-volatile storage device 120, such as a NAND flash memory device, or the like. In some embodiments, the group of memory elements 123 comprises one or more volatile memory elements 123 of volatile memory media 112. In certain embodiments, enable lines for the group of memory elements 123 are coupled together in parallel.

In some embodiments, the read module 204 sends 404 a read command to the first set 320 of one or more memory elements 123 to read data of a read request. In a further embodiment, the channel module 206 sends 406 a non-read command to a second set 320 of memory elements 123 that do not store data of the read request. In certain embodiments, the non-read command comprises a command that is not a read command, a pseudo-command, an unassigned command or opcode, a reserved opcode, a command without a function, an invalid address, or the like. In certain embodiments, the data module 202 transfers 408 data of the read request to service the read request, and the method 400 ends.

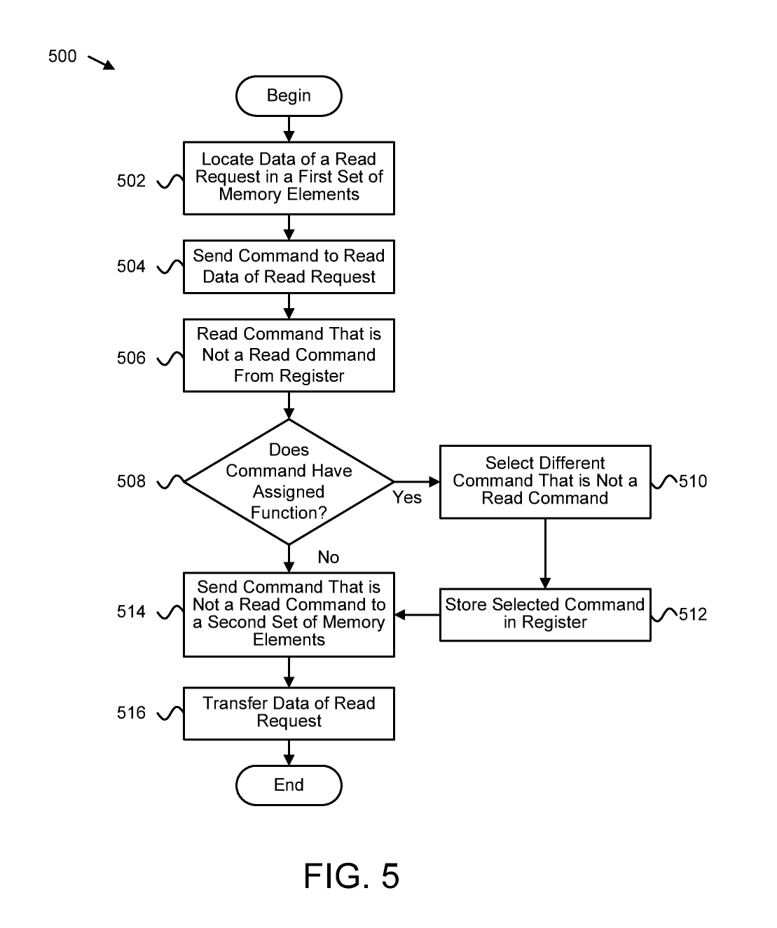

FIG. 5 depicts a further embodiment of a method 500 for a dynamic channel. In one embodiment, the method 500 begins and the data module 202 locates 502 data of a read request in a first set 320 of one or more memory elements 123 of a group of memory elements 123, such as non-volatile memory elements 123 and/or volatile memory elements 123. The read module 204 sends 504 a read command to the first set 320 of one or more memory elements 123 to read data of a read request. In certain embodiments, the command module 308 reads 506 a non-read command, e.g., a command that is not a read command, from a register for a memory element 123.

The command module 308 determines 508 whether the non-read command has been assigned an associated function. If so, the command module 308 may select 510 a different command to be the non-read command. For example, the command module 308 may select 510 a different reserved opcode, a different unassigned opcode, a different invalid address, a different pseudo-command, or the like. The command module 308 may store 512 the different non-read command in a register for the memory element 123 so that the different non-read command may be used at a future time.

The channel module 206, in certain embodiments, sends 514 the non-read command to a second set 320 of memory elements 123. The second set 320 of memory elements 123, in one embodiment, do not store data of the read request. The data module 202, in some embodiments, transfers 516 data of the read request, which may be read from the first set 320 of one or more memory elements 123, and the method 500 ends.

A means for selecting one or more memory elements 123 of a plurality of memory elements 123 for servicing a read request, in various embodiments, may include a data module 202, a command management module 150, a processor 111, a non-volatile memory controller 124, a non-volatile memory media controller 126, an SML 130, a device driver, other logic hardware, and/or other executable code stored on a computer readable storage medium. Other embodiments may include similar or equivalent means for selecting one or more memory elements 123 of a plurality of memory elements 123 for servicing a read request.

A means for sending a command to read data of a read request to a first set 320 of one or more memory elements 123 of a group of memory elements 123, which may share one or more enable lines 302 coupled together in parallel, in some embodiments, may include a read module 204, a command management module 150, a processor 111, a non-volatile memory controller 124, a non-volatile memory media controller 126, an SML 130, a device driver, other logic hardware, and/or other executable code stored on a computer readable storage medium. Other embodiments may include similar or equivalent means for sending a command to read data of a read request to a first set 320 of one or more memory elements 123 of a group of memory elements 123.

A means for sending a command that is not a read command to a second set 320 of one or more memory elements 123 of a group of memory elements 123 that do not store data of a read request, in certain embodiments, includes a channel module 206, a command management module 150, a processor 111, a non-volatile memory controller 124, a non-volatile memory media controller 126, an SML 130, a device driver, other logic hardware, and/or other executable code stored on a computer readable storage medium. Other embodiments may include similar or equivalent means for sending a command that is not a read command to a second set 320 of one or more memory elements 123 of a group of memory elements 123 that do not store data of a read request.

A means for selecting and/or storing a command that is not a read command, in one embodiment, includes a command module 208, a command management module 150, a processor 111, a non-volatile memory controller 124, a non-volatile memory media controller 126, an SML 130, a device driver, other logic hardware, and/or other executable code stored on a computer readable storage medium. Other embodiments may include similar or equivalent means for selecting and/or storing a command that is not a read command.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method comprising:
sending a command to read data of a read request to a first set of one or more memory elements of a group of memory elements, wherein enable lines for the group of memory elements are coupled together in parallel;
sending a command that is not a read command to a second set of one or more memory elements of the group of memory elements, the second set not storing data of the read request; and
transferring the data of the read request to service the read request.

2. The method of claim 1, wherein the command to read the data and the command that is not a read command are sent in parallel.

3. The method of claim 1, wherein the command that is not a read command uses less power in the second set of one or more memory elements than the command to read the data uses in the first set of one or more memory elements.

4. The method of claim 1, wherein the enable lines are connected in parallel to a single pin of a controller for the group of memory elements.

5. The method of claim 4, wherein the controller for the group of memory elements comprises one of a field-programmable gate array (FPGA) and an application-specific integrated circuit (ASIC).

6. The method of claim 1, wherein the command that is not a read command comprises a no operation (NOOP) code indicating that no operations are to be performed on the second one or more memory elements.

7. The method of claim 6, wherein the NOOP code comprises an operation code reserved by a manufacturer of the group of memory elements.

8. The method of claim 6, further comprising selecting a different command that is not a read command for a subsequent operation in response to the operation code being updated to be used by the manufacturer.

9. The method of claim 8, further comprising storing the different command that is not a read command in a register of a device comprising the group of memory elements.

10. The method of claim 1, wherein the enable lines comprise one or more of a chip enable line, a write enable line, a read enable line, a command latch enable line, and an address latch enable line.

11. The method of claim 1, further comprising sending a command to read data of a second read request to a third set of one or more memory elements of the group of memory elements in parallel with sending the command to read data of the read request and the command that is not a read command.

12. An apparatus comprising:
a read module configured to direct a read command to one or more memory die in a row of an array of memory die to service a read request using one or more input/output (I/O) lines of the one or more memory die, memory die in the row having one or more common control lines; and
a channel module configured to direct a reserved command to one or more other memory die in the row of the array of memory die, using one or more I/O lines of the one or more other memory die.

13. The apparatus of claim 13, wherein the reserved command uses less power per memory die than the read command uses per memory die.

14. The apparatus of claim 13, wherein the one or more common control lines for the row of memory die are connected to a single pin of a controller for the array of memory die.

15. The apparatus of claim 13, wherein the reserved command comprises one or more of a no operation (NOOP) code indicating that no operations are to be performed on the one or more other memory die and an invalid address for the one or more other memory die.

16. The apparatus of claim 13, wherein at least a portion of the one or more other memory die are retired from storing data.

17. A system comprising:
a first integrated circuit of storage that receives a read command;
a second integrated circuit of storage that receives a pseudo-command;
a third integrated circuit of storage that receives a read command; and
one or more enable lines electrically connecting the first, second, and third integrated circuits of storage in parallel such that the first, second, and third integrated circuits of storage are enabled in parallel to receive the read commands and the pseudo-command.

18. The system of claim 17, further comprising a controller electrically connected to the one or more enable lines, the controller sending the read command to the first integrated circuit of storage, the pseudo-command to the second integrated circuit of storage, and the read command to the third integrated circuit of storage in parallel, each in response to a read request.

19. The system of claim 18, wherein the controller comprises one of a field-programmable gate array (FPGA) and an application-specific integrated circuit (ASIC), the one or more enable lines coupled to a single pin of the controller.

20. The system of claim 17, wherein the pseudo-command comprises one of a no operation (NOOP) code indicating that no operation is to be performed on the second integrated circuit of storage and an invalid address for the second integrated circuit of storage.
